(19) United States
(12) Patent Application Publication
(10) Pub. No.: US 2025/0055879 A1
(43) Pub. Date: Feb. 13, 2025

(54) SYSTEMS AND METHODS FOR SYSTEMATIZING LINKS INCLUDED IN EMAIL MESSAGES

(71) Applicant: Dell Products, L.P., Round Rock, TX (US)

(72) Inventors: A Hema, Bangalore (IN); Saumya Joshi, Jaipur (IN)

(73) Assignee: Dell Products, L.P., Round Rock, TX (US)

(21) Appl. No.: 18/366,082

(22) Filed: Aug. 7, 2023

(51) Int. Cl. H04L 9/40; H04L 41/16

(52) U.S. Cl. CPC H04L 63/1483; H04L 41/16

(57) ABSTRACT

According to embodiments of the present disclosure, systems and methods for identifying, categorizing, and displaying links in an email message are disclosed. According to one embodiment, an Information Handling System (IHS) includes computer-executable instructions to receive a request to identify one or more links in an email message, identify one or more links in the email message, arrange each of the one or more links in one of a plurality of categories, and display the arranged links for view by a user.

### BACKGROUND

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

Electronic mail, or “email,” systems are widely deployed and have largely replaced written correspondence for both business and personal use. Examples of widely-used commercial applications commonly referred to as email clients that implement such systems include Mozilla Thunderbird, Microsoft Outlook, and Google Gmail. Nevertheless, email systems can be susceptible to phishing attacks. The term phishing is generally associated with attempts to obtain personal and/or confidential information for illegal or unauthorized purposes. Typically, a bad actor sends one or more email messages including a hyperlink to a phishing website that enables a user to enter personal and/or confidential information. Internet phishing websites make people believe that they are entering a real official website of a corporation or other organization. The phishing website usually uses a uniform resource locator (URL) with a domain name that is very similar to an actual legitimate website. The underlying internet protocol (IP) address of the official looking domain name generally routes the user to the phishing website rather than to an official website of the authentic company. When the user clicks on the hyperlink in the email or on a web page, the user is directed to the phishing website rather than to the official website.

### SUMMARY

According to one embodiment of the present disclosure, systems and methods for identifying, categorizing, and displaying links in an email message are disclosed. According to one embodiment, an Information Handling System (IHS) includes computer-executable instructions to receive a request to identify one or more links in an email message, identify one or more links in the email message, arrange each of the one or more links in one of a plurality of categories, and display the arranged links for view by a user.

According to another embodiment, an email message link identifying and categorizing method includes the steps of receiving a request to identify one or more links in an email message, and identifying one or more links in an email message. The method further includes the steps of arranging each of the one or more links in one of a plurality of categories, and displaying the arranged links for view by a user.

According to yet another embodiment, a computer program product that includes a computer readable storage medium with program instructions stored thereon that, upon execution by an Information Handling System (IHS), cause that IHS to receive a request to identify one or more links in an email message, and identify one or more links in the email message. The instructions further cause the IHS to arrange each of the one or more links in one of a plurality of categories, and display the arranged links for view by a user.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 shows an example of an IHS that may be configured to implement embodiments described herein.

FIG. 2 illustrates an example email message link identifying and categorizing system that may be used to systematize links included in email messages according to one embodiment of the present disclosure.

FIG. 3 illustrates an example link display window that may be generated by the embedded link search tool to display one or more links that were found in an email message according to one embodiment of the present disclosure.

FIG. 4 illustrates a new category entry window that may be generated by the search rules customizer for receiving user input associated with a new category according to one embodiment of the present disclosure.

FIG. 5 illustrates another example link display window showing how the embedded link search tool may utilize a learning process to enhance how the URLs of links are categorized according to one embodiment of the present disclosure.

FIG. 6 illustrates an example email message link categorizing method according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

As mentioned previously, while email messaging has become an important facet of communicating with one another, its use still presents various security problems. For example, email messages that are lengthy and have numerous links scattered in them pose difficulty when recipients attempt to locate all the links presented in various formats such as in an image, icon, text or any type of visible element, which when clicked, may direct the user to an illicit Uniform Resource Locator (URL). Users can also be tricked in instances where it is difficult to identify the difference between text and links, because they look alike and can easily be deceived through phishing attacks. Additionally, identifying URL embedded in images and icons can be burdensome. To mitigate the effects of phishing attacks, the sender of an email message should verify that any embedded links in the email message to be sent are accurate. But this is a tedious task and requires a lot of time. As will be described in detail herein below, embodiments of the present disclosure provide a system and method for systematizing links in email messages so that users can readily identify some, most, or all links included in an email message. The system and method may be particularly useful for scenarios in those email messages that include hidden or obfuscated URL links that could potentially be indicative of a phishing attack.

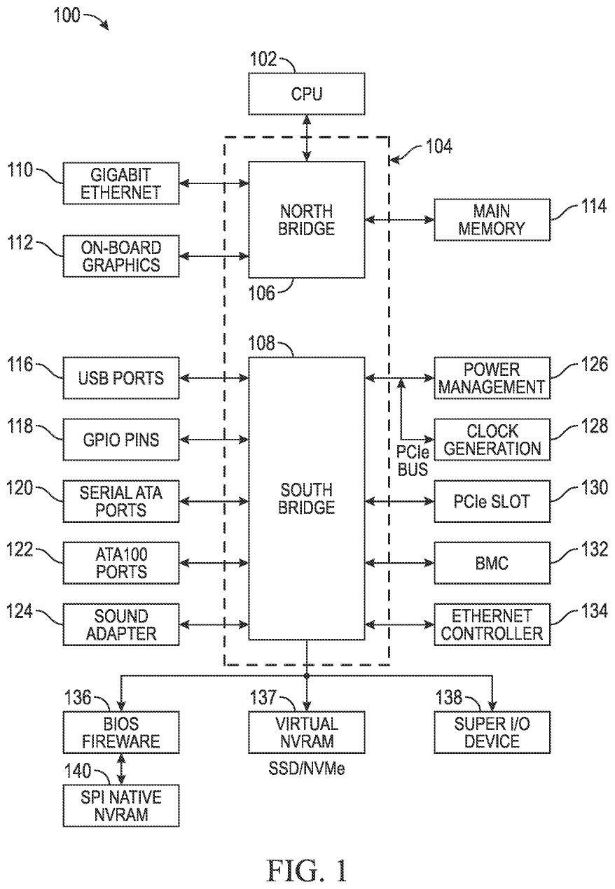

FIG. 1 shows an example of an IHS 100 that may be configured to implement embodiments described herein. It should be appreciated that although certain embodiments described herein may be discussed in the context of a desktop or server computer, other embodiments may be utilized with virtually any type of IHS 100. Particularly, the IHS 100 includes a baseboard or motherboard, to which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS 100 (e.g., a remotely located IHS 100) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 124, Ethernet controller 134, and one or more general purpose input/output (GPIO) pins 118. Southbridge 108 may also provide a bus for interfacing peripheral card devices such as PCIe slot 130. In some embodiments, the bus may include a peripheral component interconnect (PCI) bus. Southbridge 108 may also provide baseboard management controller (BMC) 132 for use in managing the various components of the IHS 100. Power management circuitry 126 and clock generation circuitry 128 may also be utilized during operation of southbridge 108.

Additionally, southbridge 108 is configured to provide one or more interfaces for connecting mass storage devices to the IHS 100. For instance, in one embodiment, southbridge 108 may include a serial advanced technology attachment (SATA) adapter for providing one or more serial ATA ports 120 and/or an ATA100 adapter for providing one or more ATA100 ports 122. Serial ATA ports 120 and ATA100 ports 122 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 130, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS 100 and to transfer information between elements within the IHS 100. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 136 to store configuration data for the IHS 100. In other embodiments, configuration data for the IHS 100 may be stored on the same virtual NVRAM 137 as BIOS/firmware 136. The IHS 100 may also include a SPI native NVRAM 140 coupled to the BIOS 136.

BMC 132 may include non-volatile memory having program instructions stored thereon that enable remote management of the IHS 100. For example, BMC 132 may enable a user to discover, configure, and manage the IHS 100, setup configuration options, resolve and administer hardware or software problems, etc. Additionally or alternatively, BMC 132 may include one or more firmware volumes, each volume having one or more firmware files used by the BIOS' firmware interface to initialize and test components of the IHS 100.

As a non-limiting example of BMC 132, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

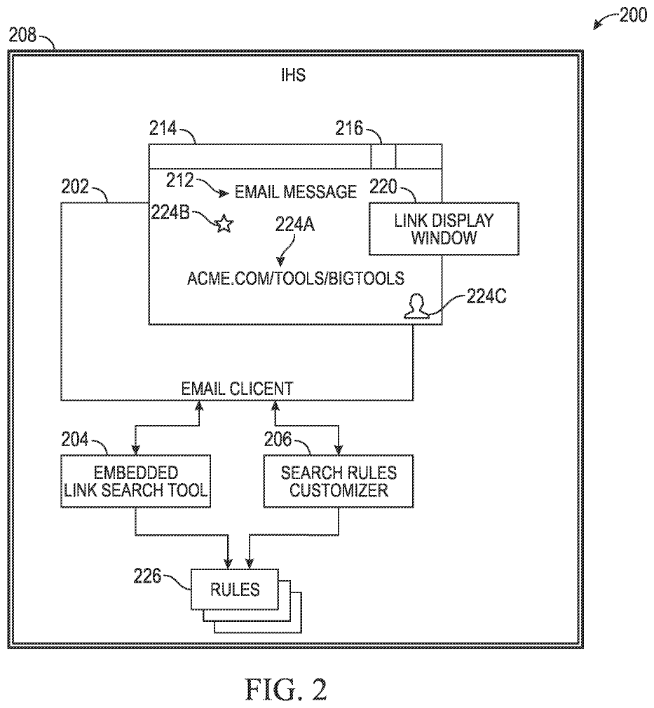

FIG. 2 illustrates an example email message link identifying and categorizing system 200 that may be used to systematize links included in email messages according to one embodiment of the present disclosure. The email message link identifying and categorizing system 200 includes an email client 202 configured with an embedded link search tool 204, and a search rules customizer 206 configured on an IHS 208. The IHS 208 may, for example, be similar in design and construction to the IHS 100 described above with reference to FIG. 1. The embedded link search tool 204 and search rules customizer 206 may include executable instructions stored in a memory and executed by at least one processor to perform the various features described herein. In one embodiment, the embedded link search tool 204 and search rules customizer 206 may be provided as a plug-in that can be added to the email client 202. In another embodiment, the embedded link search tool 204 and search rules customizer 206 may be provided in any suitable form, such as via executable instructions that form an integral part of the email client 202.

The email client 202 generates a message window 210 that displays a particular email message 212 selected by a user from the email client 202. The message window 210 displays information included in the message 212 along with a toolbar 214 extending along an upper edge of the window 210. The toolbar 214 includes a button 216, which when selected by the user, causes the embedded link search tool 204 to search through the email message 212 for links 224 included in the email message window 210, and display the links (e.g., hotlinks, inline links, direct links, etc.) that were found in a link display window 220, such as a pop-up window.

The links 224a-c (collectively 224) may include any type that causes the IHS 208 to perform an action, such as accessing a website external to the email message 212. For example, a link 224 may be a URL of a website that may be accessed using a web browser configured on the IHS 208. The link 224a as shown on the email message 212, may be shown on the email message 212 as alpha-numeric text characters explicitly indicating to the user that it is a link. In some cases, however, the link 224 may be hidden. For example, one link 224b may be an icon that when selected by the user (e.g., point and left-click with a mouse), causes an underlying URL to be accessed by the web browser of the IHS 208. Another link 224c may be an image (e.g., photograph) that when selected, causes its underlying URL to be accessed by the browser. Hidden links 224b-c such as these may cause problems, particularly when used through phishing attacks. Even when the user provides no information to the website accessed by the hidden URL, the website may still garner information about the user by indicating a particular date and time in which the hidden URL was accessed. Embodiments of the present disclosure provide a solution to this problem, among others, by searching through an email message 212 for any links 224 and displaying the links 224 on a pop-up window 220 so that the user may be made aware of those links 224.

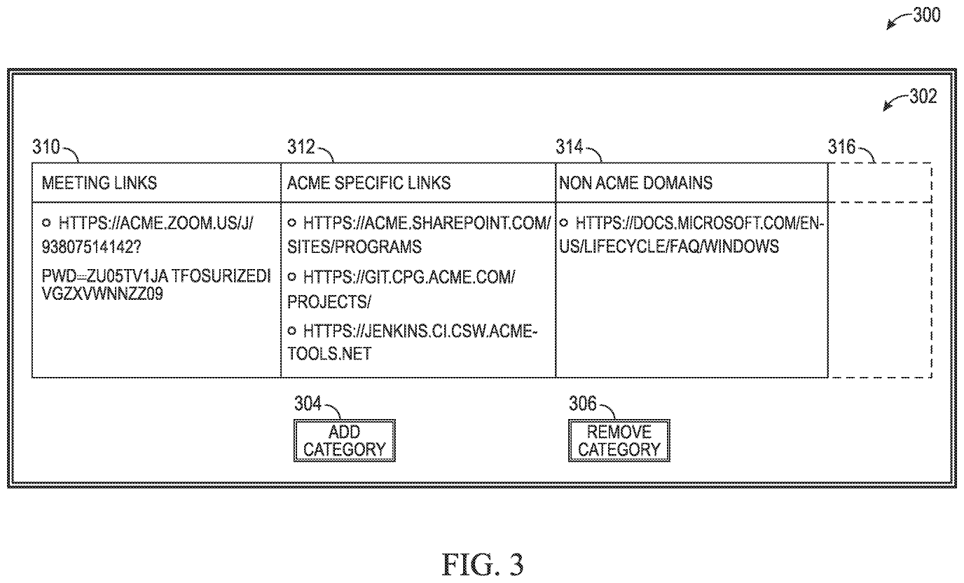

FIG. 3 illustrates an example link display window 300 that may be generated by the embedded link search tool 204 to display one or more links 224 that were found in an email message 212 according to one embodiment of the present disclosure. The link display window 300 may, for example, be generated by the embedded link search tool 204 in response to selection of the button 216 by the user. The link display window 300 includes a table portion 302 and one or more action buttons that enable the user to control operation of the system 200. In particular, the action buttons include an “Add Category” button 304 and a “Remove Category” button 306.

The table portion 302 displays the links 224 found in the email message 212 according to each of multiple categories. As shown, the table portion 302 includes a meetings category 310, a work-related category 312, and a non-work-related category 314. When the embedded link search tool 204 finds the links 224 in the email message 212, it may include logic to categorize each link according to one of the established categories in the table portion 302. For example, the embedded link search tool 204 has determined that a URL to a particular link is a meeting type link and therefore, displays that URL in the meetings category 310. Similar actions may be taken for the other links 224 found in the email message 212.

According to one embodiment, the search rules customizer 206 may include logic for customizing the categories provided in the table portion 302. For example, upon selection of an existing category 310, 312, or 314 followed by selection of the “Remove Category” button 306, the search rules customizer 206 may remove the selected, existing category 310, 312, or 314 from the table portion 302. Conversely, upon selection of the “Add Category” button 304 by the user, the search rules customizer 206 may generate a new category 316 in the table portion 302 of the link display window 300.

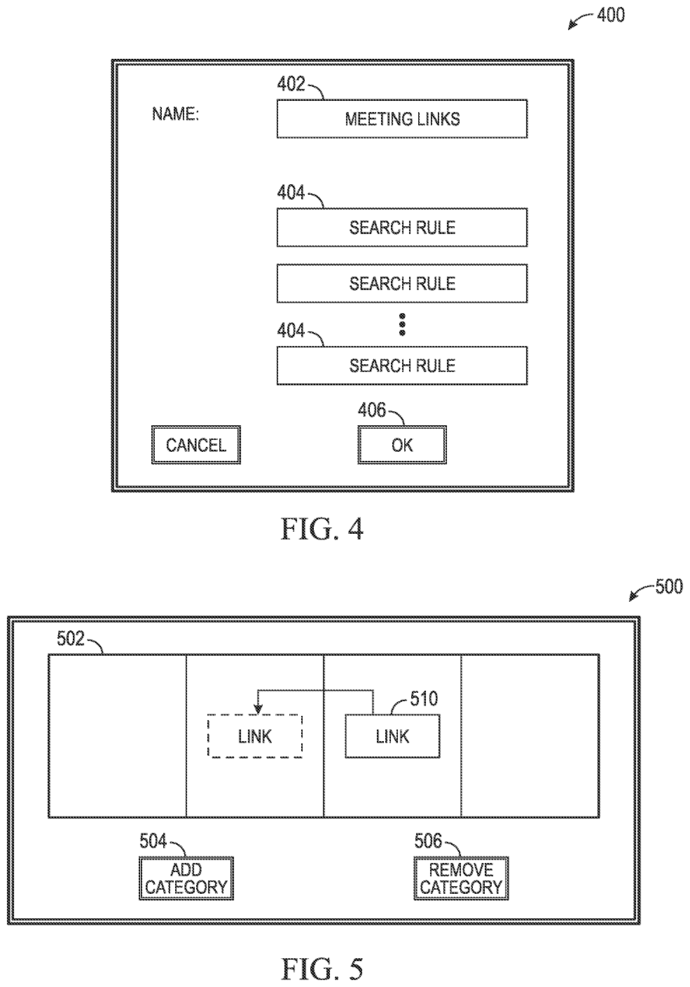

FIG. 4 illustrates a new category entry window 400 that may be generated by the search rules customizer 206 for receiving user input associated with a new category 316 according to one embodiment of the present disclosure. For example, the new category entry window 400 may be generated by the search rules customizer 206 in response to user selection of the “Add Category” button 304 as shown a described with reference to FIG. 3 above. In general, the new category entry window 400 may be used to receive any suitable type of user input in which the embedded link search tool 204 may be used to categorize links 224 that have been found.

As shown, the new category entry window 400 includes a name entry field 402 and one or more search rules entry fields 404. The name entry field 402 is configured to be populated with any type of free-form text information for identifying the type of category by the user. Examples of categories may include professional organizations that the user is involved with, advertising links, personal links, potential malicious links, miscellaneous links, and the like. The search rules entry fields 404 may be populated with criteria that may be used by the embedded link search tool 204 to determine that a particular link 224 belongs in that category. For example, criteria that may be populated in the search rules entry fields 404 may include keywords, a certain combination of multiple keywords, a whole URL, and/or a portion of a URL (e.g., a URL prefix, a URL suffix, etc.). In one embodiment, the link display window 300 may include a miscellaneous links category for those links 224 that cannot be resolved to a particular category by the embedded link search tool 204.

According to one embodiment, the link display window 300 may include a potential malicious links category in which those links 224 that are deemed to be malicious may be displayed. For example, the embedded link search tool 204 may include a Machine Learning (ML) process that continually monitors links 224 detected by the email message link identifying and categorizing system 200, and highlights those links 224 that are inferred to be malicious. In one embodiment, the embedded link search tool 204 may collaborate with the ML processes of the embedded link search tool 204 executed on other IHSs 208 to share information over the cloud (e.g., the Internet) about links 224 that have proven or likely to be malicious. Using that shared information, the embedded link search tool 204 may identify those potentially malicious links 224 and highlight them to make the user aware of the potentially malicious links 224.

Following user entry of the name entry field 402 and the search rules entry fields 404, followed by user selection of the “OK” button 406, the search rules customizer 206 may add the criteria entered in the search rules entry fields 404 to the search rules 226. Thus, when the embedded link search tool 204 categorizes the links 224, it may use the search rules 226 to determine which category 310, 312, 314, or 316 to which the link 224 belongs.

FIG. 5 illustrates another example link display window 500 showing how the embedded link search tool 204 may utilize a learning process to enhance how the URLs of links 224 are categorized according to one embodiment of the present disclosure. The link display window 500 includes a table portion 502 and one or more action buttons 504 and 506 that that may be at least partially similar in design and construction to the table portion 302 and action buttons 304 and 306 of FIG. 3.

According to one embodiment, the embedded link search tool 204 may use a Machine Learning (ML) process for continual, ongoing optimization of how links 224 are categorized. Nevertheless, the embedded link search tool 204 may incorrectly categorize from time to time. As such, the embedded link search tool 204 may display the link display window 500 in a manner so that the user may selectively move a URL 510 associated with a link 224 from one category to another. When this occurs, the embedded link search tool 204 may, using the ML engine, update its search rules 226 to indicate that the URL 510 should be categorized in the category specified by the user. Thus, for ensuing search operations, the embedded link search tool 204 may categorize that link 224 as well as other links 224 with a slightly different URL to be categorized in that category specified by the user.

While FIGS. 3 through 5 describe example windows 300, 400, and 500 that may be used by the embedded link search tool 204 and search rules customizer 206 for finding, categorizing, and displaying links 224 in an email message 212, it should be appreciated that the system 200 may display other types of windows without deviating from the spirit and scope of the present disclosure. For example, either of the windows 300, 400, and 500 may include additional, fewer, or different features than what is shown and described herein. Additionally, the email message link identifying and categorizing system 200 may generate additional, fewer, or different types of windows than what is shown and described herein. Also, either of the embedded link search tool 204 and search rules customizer 206 may perform any of the actions described herein, and in some cases, some, most, or all actions of the email message link identifying and categorizing system 200 may be integrated into a single executable process.

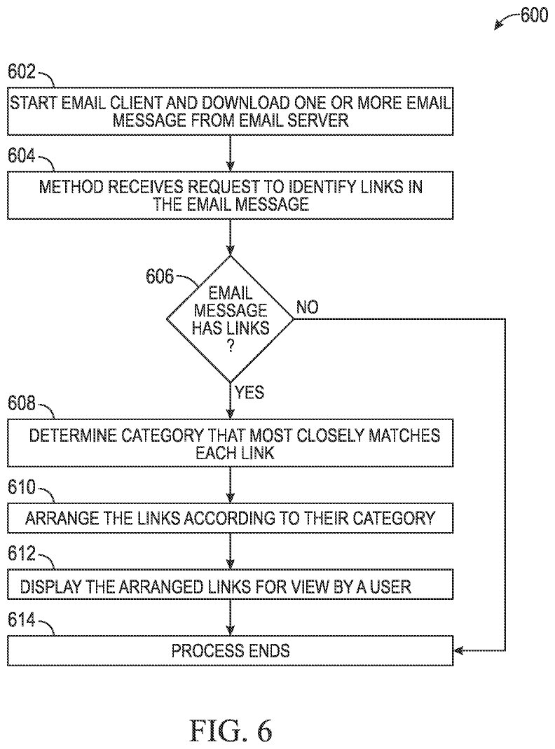

FIG. 6 illustrates an example email message link categorizing method 600 according to one embodiment of the present disclosure. Additionally or alternatively, the method 600 may be performed by the email message link identifying and categorizing system 200 as described above with reference to FIG. 2. In a particular example, the email message link categorizing method 600 may be performed at any suitable time. In one embodiment, the email message link identifying and categorizing method 600 may be performed in response to user selection of a button 216, or other user input technique. In another embodiment, the method 600 may be performed each time the user selects an email message for view to identify and display the links 224 included in that email message. Although the email message link identifying and categorizing method 600 described below is directed to identifying, categorizing, and displaying the links in a single email message, it is contemplated that the method 600 may also be directed to searching, categorizing, and displaying the links of multiple email messages, such as some, most, or all email messages in a user's inbox.

Initially at step 602, an email client 202 is started on the IHS 208 and one or more email messages are downloaded from an email server. Thereafter at step 604, the method 600 receives a request to identify any links 224 in an email message 212. For example, the user may open one of the downloaded email messages 212 to display its contents, and select the button 216 that causes the embedded link search tool 204 to search through the email message 212 for links 224 included in the email message.

The email message link identifying and categorizing method 600 then determines whether any links 224 exist in the email message 212 at step 606. If so, the method 600 continues at step 608; otherwise, it continues at step 614 in which the method 600 ends. At step 608, the method 600 determines for each identified link 224, which category it is most closely associated with. Any quantity and types of categories can exist. For example, the method 600 may possess certain default categories, such as a work related category, a non-work related category, and a miscellaneous category. Additionally, categories may be added, edited, or removed based upon the user's requirements.

In one embodiment, the email message link identifying and categorizing method 600 determines which category each identified link 224 belongs to using a ML process. For example, the ML process may compare any identified links 224 with previously identified links to determine which category that a link 224 should belong to. The ML process may also collaborate with other online sources, such as ML processes running on other email clients to assist in determining which category each link 224 should belong to. In one embodiment, the ML process may learn from links 224 that are manually migrated from one category to another, such as described above with reference to FIG. 5, so that the categorization process may be continually optimized.

At step 610, the email message link identifying and categorizing method 600 arranges the identified links 224 according to their category, and at step 612, it displays the links 224 for view by the user. In one embodiment, the links 224 are displayed as a table with each column representing a different category. In another embodiment, the email message link identifying and categorizing method 600 may employ a ML process that determines whether any links 224 are harmful or malicious and if so, highlight those links 224 to alert the user.

The aforedescribed method 600 may be performed for each email message received by the email client. Nevertheless, when use of the email message link identifying and categorizing method 600 is no longer needed or desired, the email message link identifying and categorizing method 600 ends.

Although FIG. 6 describes an example method 600 that may be performed to identify, categorize, and display the links 224 in an email message 212, the features of the method 600 may be embodied in other specific forms without deviating from the spirit and scope of the present disclosure. For example, either of the method 600 may perform additional, fewer, or different operations than those described in the present examples. For another example, either of the method 600 may be performed in a sequence of steps different from that described above. As yet another example, certain steps of the method 600 may be performed by other components in the IHS 208 other than those described above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” when used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
a processor; and
a memory coupled to the processor, the memory having program instructions stored thereon that, upon execution, cause the Information Handling System (IHS) to:
receive a request to identify one or more links in an email message;
identify one or more links in the email message;
arrange each of the one or more links in one of a plurality of categories; and
display the arranged links for view by a user.

2. The IHS of claim 1, wherein the program instructions, upon execution, further cause the IHS to receive the request according to user input.

3. The IHS of claim 1, wherein the program instructions, upon execution, further cause the IHS to display a plurality of Uniform Resource Locators (URLs) associated with the links.

4. The IHS of claim 1, wherein the program instructions, upon execution, further cause the IHS to display the links in a table with each column representing one of the plurality of categories.

5. The IHS of claim 1, wherein the program instructions, upon execution, further cause the IHS to identify the one or more links using a Machine Learning (ML) process.

6. The IHS of claim 5, wherein the program instructions, upon execution, further cause the IHS to, using the ML process, identify one or more malicious links, and highlight the identified malicious links displayed for the user.

7. The IHS of claim 5, wherein the program instructions, upon execution, further cause the IHS to:
receive user input for migrating at least one link from one category to another category; and
use the migrated link to train the ML process.

8. The IHS of claim 1, wherein the program instructions, upon execution, further cause the IHS to:
receive user input for adding another category and one or more criteria to be associated with the additional category; and
establish the additional category according to the user input.

9. The IHS of claim 1, wherein the acts of identifying the one or more links, arranging each of the links, and displaying the arranged links are performed by a plugin configured with an email client that stores the email message.

10. The IHS of claim 1, wherein the one or more links comprise at least one of an alpha-numerical text string, an icon, or an image.

11. An email message link identifying and categorizing method comprising:
receiving a request to identify one or more links in an email message;
identifying one or more links in an email message;
arranging each of the one or more links in one of a plurality of categories; and
displaying the arranged links for view by a user.

12. The email message link identifying and categorizing method of claim 11, further comprising receiving the request according to user input.

13. The email message link identifying and categorizing method of claim 11, further comprising displaying a plurality of Uniform Resource Locators (URLs) associated with the links.

14. The email message link identifying and categorizing method of claim 11, further comprising displaying the links in a table with each column representing one of the plurality of categories.

15. The email message link identifying and categorizing method of claim 1, further comprising identifying the one or more links using a Machine Learning (ML) process.

16. The email message link identifying and categorizing method of claim 15, further comprising identifying, using the ML process, one or more malicious links, and highlighting the identified malicious links displayed for the user.

17. The email message link identifying and categorizing method of claim 15, further comprising:
receiving user input for migrating at least one link from one category to another category; and
using the migrated link to train the ML process.

18. The email message link identifying and categorizing method of claim 11, further comprising:
receiving user input for adding another category and one or more criteria to be associated with the additional category; and
establishing the additional category according to the user input.

19. A computer program product comprising a computer readable storage medium having program instructions stored thereon that, upon execution by an Information Handling System (IHS), cause the IHS to:
receive a request to identify one or more links in an email message;
identify one or more links in the email message;
arrange each of the one or more links in one of a plurality of categories; and
display the arranged links for view by a user.

20. The computer program product of claim 19, wherein the program instructions, upon execution, further cause the IHS to, using the ML process, identify one or more malicious links, and highlight the identified malicious links displayed for the user.
